(19) United States
(12) Patent Application Publication
(10) Pub. No.: US 2026/0309246 A1
(43) Pub. Date: Oct. 8, 2026

(54) OVERPRESSURE SAFETY VALVE

(71) Applicant: LESER GmbH & Co. KG, Hamburg (DE)

(72) Inventor: Thomas RAEDER, Hamburg (DE)

(21) Appl. No.: 18/993,044

(22) PCT Filed: Jul. 10, 2023
(86) PCT No.: PCT/EP2023/069031

§ 371 Date: Jan. 10, 2025

(30) Foreign Application Priority Data
Jul. 13, 2022 (EP) 22184772.6

(51) Int. Cl. F16K 17/04

(52) U.S. Cl. CPC F16K 17/0413

(57) ABSTRACT

An overpressure safety valve which is configured to open on exceeding a pressure maximal value. The valve element (10) is movable along a valve axis (x), with a pressure side (28) and an outlet side (30) which is away from the pressure side (28) in the direction of the valve axis (x). The valve element (10) at its outlet side (30) is connected to at least one resistance element (32) which is distanced to the valve element (10) and is situated in a flow path at the exit side of the valve element (10).

### CROSS REFERENCE TO RELATED APPLICATIONS

This application is a United States National Phase Application of International Application PCT/EP2023/069031, filed Jul. 10, 2023, and claims the benefit of priority under 35 U.S.C. § 119 of European Application 22184772.6, filed Jul. 13, 2022, the entire contents of which are incorporated herein by reference.

### TECHNICAL FIELD

The invention relates to an overpressure safety valve which is designed to open on exceeding a pressure maximal value.

### BACKGROUND

Such overpressure safety valves are applied in machines and industrial facilities, in order in the case of too high a pressure in a conduit system and/or container system to discharge the medium in the system, for example gas or vapour, in a controlled manner via the safety valve and to reduce the pressure. For this, spring-biased valves are known, concerning which a pressure maximal value is set by the spring force. The problem of such valves is the behaviour on opening, since pressure changes occur at the pressure side and well as at the outlet side on opening the valve, said pressure changes possibly leading to an oscillation of the valve element, so that a rapid controlled pressure reduction is not possible without further ado.

### SUMMARY

It is the object of the invention to improve an overpressure safety valve in manner such that it has a more stable behaviour on opening.

This object is achieved by an overpressure safety valve with features according to the invention. Preferred embodiments are disclosed in the description, the claims and the attached figures.

The overpressure safety valve according to the invention is designed to open on exceeding a pressure maximal value at a pressure side of the safety valve. For this, the overpressure safety valve comprises a valve element which is movable along a valve axis, with a pressure side and an outlet side which is away from the pressure side in the direction of the valve axis. The pressure which acts upon the pressure side of the valve element effects an opening of the valve element when the pressure maximal value is exceeded, wherein then the medium can flow around the opened valve element and be led away at the outlet side. According to the invention, the valve element at its outlet side is connected to at least one resistance element. This is arranged such that it is distanced to the valve element, in particular to its outlet side. Moreover, the resistance element is situated in a flow path at the exit side, i.e. at the outlet side of the valve element. Thus the resistance element forms at least one surface, upon which a fluid flow can act, said fluid flow flowing past the valve element when this is located in its opened position. The flow which impinges the resistance element herewith generates a force which acts upon the resistance element. Since the resistance element is connected to the valve element, the force also acts upon the valve element and can therefore contribute to minimising its undesirable oscillation behaviour. Particularly preferably, the resistance element is arranged such that the flow upon the resistance element generates a force which acts in the opening direction of the valve element and which herewith assists in the opening procedure of the valve element and prevents an undesired closure due to occurring oscillations. Since the resistance element is distanced to the valve element at the outlet side of this, the resistance element is subjected to force by the exiting flow with a temporal delay with respect to the valve element. Hence a slight phase shift occurs between the forces, said phase shift contributing to the stabilisation of the opening behaviour, in particular helping with the avoidance of undesired oscillations.

The resistance element hence forms a structure which is situated in the flow path at the outlet side of the valve element and which comes into contact with the exiting fluid flow and is designed such that the fluid flow acts upon the structure, so that a stabilising force, preferably one which reduces an oscillation is imparted upon the valve element via the structure. By way of a suitable design of the structure, i.e. of the at least one resistance element, the size and direction of the forces which are generated by the fluid flow upon the valve element can be adapted, in order to ensure a desired behaviour of the valve element on opening.

The at least one resistance element can be designed in a disc-like manner. The resistance element can thus project for example in a disc-like manner in the radial direction from a stem which carries the valve element, as is described in more detail hereinafter, so that the disc-like resistance element forms a projection, upon which a fluid flow or a fluid pressure can act. The disc-like resistance element can herein be designed in a planar manner with parallel surfaces but also with curved or angled surfaces.

According to a possible embodiment, the at least one resistance element comprises at least one angled surface which preferably extends transversely and further preferably normally to the valve axis. This surface can further preferably extend essentially parallel to the pressure side of the valve element. By way of adapting the surface of the resistance element, the force action upon the resistance element can be optimised such that a desired additional force and a desired additional oscillation behaviour of the system, consisting of the resistance element and the valve element, can be realised, or that undesirable oscillations can be prevented in the best possible manner.

According to a further possible embodiment, the resistance element can comprise an angled-away wall or collar on at least one surface, preferably on a surface which faces the valve element, on its outer circumference. For example, the resistance element can also be designed in a pot-like manner, wherein the angled-away wall can form an annular, particularly preferably cylindrical collar which is preferably directed towards the valve seat. By way of the collar, a circumferentially limited space is created below the resistance element, i.e. at the side of the resistance element which faces the valve element, in which space a dynamic pressure can form, said dynamic pressure exerting a force upon the resistance element.

According to a further possible embodiment of the invention, a free space is formed in the circumferential region of the valve element, preferably also in the circumferential region of the at least one resistance element. The free space is preferably an annular free space between the outer circumference of the valve element and/or the outer circumference of the at least one resistance element and a surrounding housing part. The free space permits the exiting flow to be able to flow past the valve element to the resistance element. Moreover, inasmuch as the free space is formed in the circumferential region of the resistance element, the flow can also flow around the resistance element, in order to act upon both sides of the resistance element and/or to impinge subsequent resistance elements in the case that several resistance elements are arranged in a successive manner.

The radial extension of the resistance element with respect to the valve axis x can be larger or smaller than the axial extension of the valve element. Herein, it is possible for the radial extension of the resistance element over its entire circumference to be smaller or larger than the radial extension of the valve element. However, it is also conceivable for the resistance element to project beyond the extension of the valve element in the radial direction in individual circumferential regions and/or to have a smaller radial extension than the valve element only in individual circumferential regions.

The valve element is preferably designed as a valve disc which with its pressure side can come into sealing bearing contact on a valve seat. The valve seat is preferably an annular contact surface or contact edge, which surrounds a pressure conduit or a pressure region. This pressure region is closed by way of the valve element which bears on the valve seat. The fluid pressure in the inside of the pressure region effects a force upon the valve element, said force on exceeding the predefined pressure maximal valve lifting the valve element from the valve seat and thus opening the safety valve.

According to a further preferred embodiment, the valve element can be designed in a pot-like manner with an annular wall which surrounds the valve seat or with a collar which surrounds the valve seat. I.e. the valve element can be designed as a valve disc which bears on an annular valve seat, wherein an annular wall or a collar projects from the valve disc in the direction of the valve seat in a manner such that it circumferentially surrounds the valve seat. The annular wall or the collar can extend parallel to the valve axis or at an angle to the valve axis.

The valve element is preferably spring-biased and is forced into a position which bears on the valve seat by way of the spring biasing. The spring biasing is herein set such that the force which is exerted upon the valve element by the spring biasing defines the mentioned pressure maximal value, on exceeding which the valve element lifts from the valve seat. The spring biasing can be mustered for example by a helical spring in the known manner, wherein the spring force can be preset by way of changing the compression of the spring.

According to an embodiment of the invention, the valve element at its outlet side comprises a stem which extends in the direction of the valve axis and which carries the at least one resistance element. I.e. the resistance element is fastened to the stem and/or is formed with this as one piece. The stem can be fastened e.g. to the valve element or be formed with this as one piece. A multi-piece stem construction or a different suitable connection structure between the valve element and resistance element is also possible. The stem can simultaneously serve for guiding the valve element in its movement direction along the valve axis. The stem or a connection structure serves for the force transmission from the resistance element onto the valve element, so that the forces which act upon the resistance element are transmitted onto the valve element or the resistance element with the valve element forms a common system.

According to a further possible embodiment, the at least one resistance element can comprise a surface which extends obliquely to the valve axis. Herein, two surfaces which are away from one another in the direction of the valve axis can extend obliquely, wherein the surfaces can extend in parallel or also angled to one another. It is also conceivable for a surface to extend essentially normally to the valve axis and the other surface to extend obliquely to the valve axis. The surfaces can also be angled per se and/or corrugated. A further optimisation of the force engagement surfaces can be effected in a desired manner by way of the design of the surfaces, in order to be able to influence the opening behaviour of the valve element in a defined manner.

It is also possible for the at least one resistance element to comprise at least one curved surface. The effective surfaces can also be adapted in a desired manner by way of this. Moreover, the flow resistance, if desired, can be reduced or influenced in a desired manner by way of oblique and curved surfaces.

According to a further possible embodiment, the at least one resistance element can taper outwards in a direction radial to the valve axis. This can be realised for example by way of two surfaces of the valve element which are away from one another accordingly extending obliquely to the valve axis or being designed curved in a suitable manner.

The at least one resistance element can be designed or arranged symmetrically to the valve axis. Alternatively, it is possible for the at least one resistance element to be designed asymmetrically to the valve axis, preferably projecting further in the radial direction with respect to the valve axis in a first circumferential region than in a second circumferential region. Such an asymmetry can be effected e.g. from a suitable adaption to the surrounding housing geometry of the valve housing. The valve housing is thus also possibly designed in an asymmetrical manner, in particular if an outlet conduit connects in a direction radial to the valve axis. The asymmetrical design of the resistance element can be matched to the shape of the valve housing such that a fluid flow in the valve housing impinges the resistance element with force in an optimal manner.

According to the invention, at least one resistance element is provided. It is also possible to arrange several resistance elements in a successive manner and distanced to one another in the direction of the valve axis. The several resistance elements can be designed identically or also differently, preferably in one of the aforementioned embodiments. According to a particular embodiment of the invention, several resistance elements, for example two or three resistance elements can be arranged successively in a distanced manner and each designed in a disc-like manner and at their surface which faces the valve element comprise a projecting collar on the outer circumference. If several resistance elements are provided, then several resistance elements do not each need to extend around the valve axis over the whole circumference. In contrast, it is also possible for several resistance elements to be arranged successively and distanced to one another only in at least one circumferential region with respect to the valve axis, whilst only one resistance element is arranged in another circumferential region. An offset arrangement is also conceivable. An asymmetry e.g. permits an adaption to the surrounding valve housing, so that the fluid flow which is led through the valve housing can act upon the resistance element in the desired manner and the desired forces exerted upon the system of the valve element and resistance element.

According to a further possible embodiment of the invention, a cylinder wall can be arranged at the outlet side of the valve element at a distance to the valve seat in a manner such that at least on opening the valve a resistance element enters into a space which is surrounded by the cylinder wall. Particularly preferably, the resistance element with the cylinder wall forms a piston-cylinder arrangement, concerning which the fluid pressure thus predominately acts upon one side of the resistance element, specifically the side which faces the valve seat. The second remote side of the valve element then faces an interior which is enclosed by the cylinder wall and in which preferably a lower pressure prevails, so that an additional opening force can be exerted upon the valve element by way of pressure impingement of the resistance element from one side.

The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a schematic view of an overpressure safety valve according to the invention;

FIG. 2 is a schematic view of a possible embodiment of at least one resistance element;

FIG. 3 is a schematic view of a possible embodiment of the resistance element;

FIG. 4 is a schematic view of a possible embodiment of the resistance elements;

FIG. 5 is a schematic view of a possible embodiment of at least one resistance element;

FIG. 6 is a schematic view of a possible embodiment of at least one resistance element;

FIG. 7 is a schematic view of a possible embodiment of at least one resistance element;

FIG. 8 is a schematic view of a possible embodiment of at least one resistance element;

FIG. 9 is a schematic view of a possible embodiment of at least one resistance element;

FIG. 10 is a schematic view of a possible embodiment of at least one resistance element;

FIG. 11 is a schematic view of a possible embodiment of at least one resistance element;

FIG. 12 is a schematic view of a possible embodiment of the resistance element;

FIG. 13 is a schematic view of a possible embodiment of the resistance element;

FIG. 14 is a schematic view of a possible embodiment of the resistance element;

FIG. 15 is a schematic plan view of a further possible arrangement of a least one resistance element; and

FIG. 16 is a schematic plan view of a further possible arrangement of at least one resistance element; and

FIG. 17 is a schematic and in an enlarged manner, a valve element with a resistance element as is shown in FIG. 1.

### DESCRIPTION OF PREFERRED EMBODIMENTS

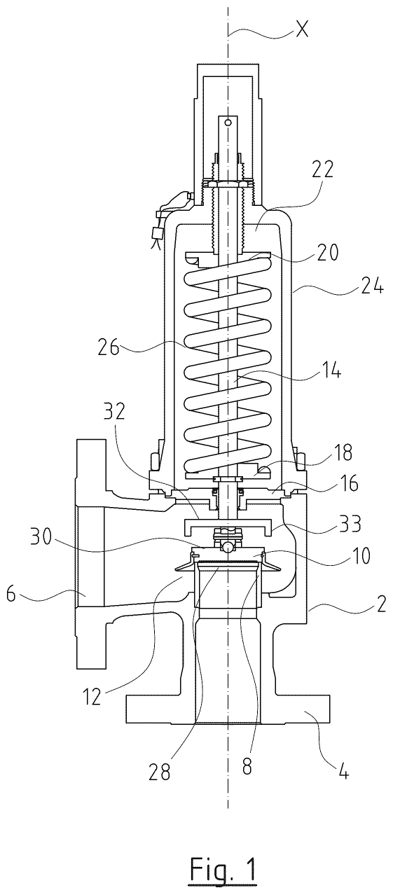

Referring to the drawings, FIG. 1 schematically shows the complete construction of an overpressure safety valve according to the invention, said valve corresponding essentially to the conventional construction of an overpressure safety valve. The valve housing 2 comprises a pressure connection stub 4 as well as a discharge connection stub 6. The overpressure safety valve is connected to a pressure conduit or to a pressure container via the pressure connection stub 4. A discharge conduit, a discharge container or the like can connect to the discharge connection stub 6. An annular valve seat 8, on which a disc-like valve element 10 is held in a sealing bearing contact is arranged in the inside of the valve housing 2 in a manner connecting to the pressure connection stub 4. The valve element 10 comprises a circumferential collar 12 which surrounds the valve seat 8. A stem 14 which is guided in a guide plate 16 in a lineally movable manner in the direction of the valve axis x is fastened to the valve element 10. A first contact disc 18 is fastened to the stem 14, so that this disc can move together with the stem 14 along the valve axis x. A second contact disc 20 is supported via a threaded sleeve 22 on the spring housing 24 which is connected to the valve housing 2. A compression spring 26 in the manner of a helical spring is arranged between the contact discs 18 and 20. The compression of the compression spring 26 can be varied by way of adjusting the threaded sleeve 22, in order to be able to set the opening pressure, i.e. maximal pressure value, on exceeding which the overpressure safety valve is to open. The fluid pressure in the inside of the pressure connection stub 4 presses against the pressure side 28 of the valve element 10. If the force which is exerted upon the valve element 10 by this pressure exceeds the force which is generated by the compression spring 26, then the valve element 10 lifts from the valve seat 8 and the fluid can flow out of the pressure connection stub 4 into the discharge connection stub 6.

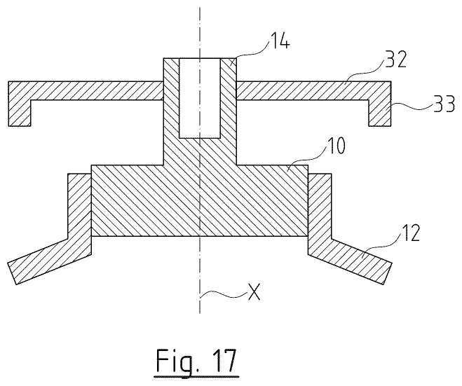

After the lifting of the valve element 10 from the valve seat 8, the pressure conditions in the environment of the valve element 10 change. The pressure reduces in the pressure connection stub 4, whereas the pressure in the outlet connection stub 6 and in particular at the outlet side 30 of the valve element 10 increases. This can lead to an instable opening state, in which the valve element 10 oscillates in an undesirable manner. In order to minimise such an undesired oscillation and to stabilise the opening procedure, an additional structure in the form of a resistance element 32 which is situated in the flow path is arranged on the valve element in a manner distanced to the outlet side in the direction of the valve axis x. The resistance element 32 is fastened to the stem 14 and/or directly on the valve element 10, so that it is distanced to the outlet side 30 of the valve element 10. The resistance element 32 in this example is designed in a disc-like manner and comprises two surfaces which extend transversely to the valve axis x. The resistance element 32 on its surface which faces the valve element 10 comprises an angled wall 33 on the outer circumference of this surface, said wall forming a cylinder-shaped collar which extends essentially concentrically to the valve axis x. In this manner, a space which is circumferentially limited by the angled wall 33 is created below the resistance element 32, in which space a dynamic pressure can form. This particular embodiment is shown once again in detail in FIG. 17. The resistance element 32 lies in the inside of the valve housing 2 in the flow path through which a fluid flow flows, said fluid flow exiting between the valve seat 8 and the valve element 10. In this embodiment example, the valve element 10 and the resistance element 32 are circumferentially surrounded by a free space, through which a fluid flow can be effected. Such a fluid flow flows around the valve element 10 and hence in particular impinges the surface of the resistance element 32 which faces the outlet side 30, so that this flow via the resistance element 32 exerts a force upon the stem 14 and thus upon the complete system consisting of the valve element 10 and the resistance element 32. This force helps to stabilise the opening procedure and to reduce undesirable oscillations. The resistance element 32 is distanced to the valve element 10 in the direction of the valve axis X. The force impingment of the resistance element 32 on opening the valve is thus effected in a time-delayed manner to the force impingment of the valve element 10, so at a phase shift can occur, by which means a greater oscillation of the system can be prevented.

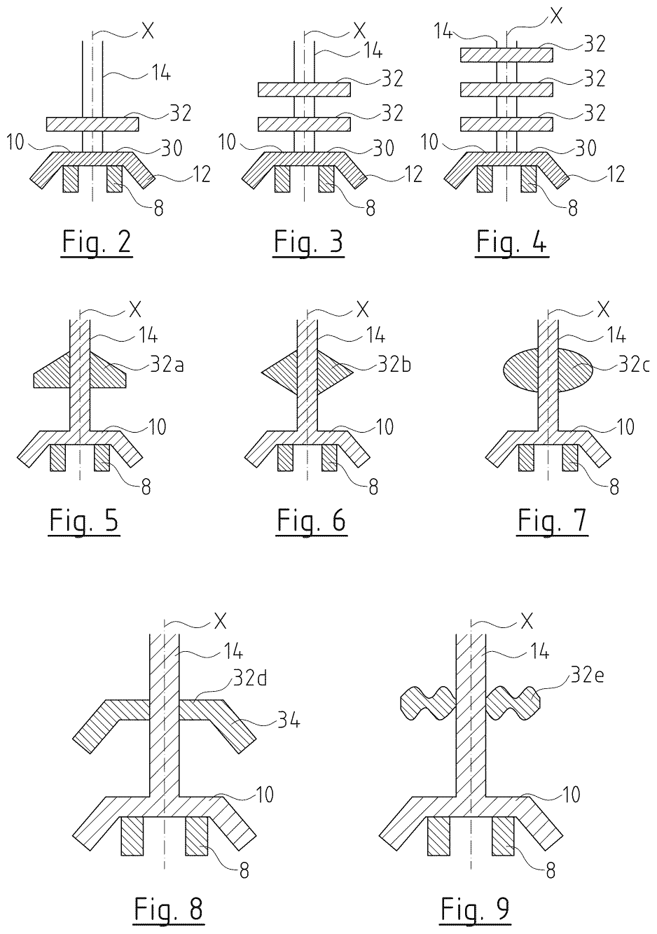

Such a resistance element 32 or several such resistance elements 32 can be designed in the most varied of manners. FIGS. 2 to 16 schematically show possible embodiments of one or more resistance elements, wherein this is not to be understood as a conclusive listing.

FIG. 2 essentially shows the embodiment as has been described by way of FIG. 1. Regarding the embodiment according to FIG. 3, two resistance elements 32 are arranged in a successive manner and distanced to one another. FIG. 4 shows an embodiment example concerning which three disc-like resistance elements 32 are arranged distanced to one another at the outlet side 30 of the valve element 10. Several surfaces which lie one after the other are created by the arrangement of several disc-like resistance elements 32 as is shown in FIGS. 3 and 4, on which surfaces the fluid flow can engage at the outlet side of the valve element 10, so that as a whole a larger force which acts upon the stem 14 in the direction of the valve axis x can be generated.

FIG. 5 schematically shows a differently shaped resistance element 32a which at its side which is away from the valve element 10 is shaped in a cone-like manner and at its side which faces the valve element 10 has a surface which extends transversely to the valve axis x, as also the resistance element 32 according to FIGS. 2 to 4. The surface which is on the side which is away from the valve element 10 and which runs obliquely to the valve axis x can effect an improved flow guidance.

In the embodiment example according to FIG. 6, the surface of the resistance element 32b which faces the valve element 10 is also designed in a cone-like manner, i.e. runs obliquely to the valve axis x. The resistance element 32c according to FIG. 7 as a whole comprises a lens-like shape, i.e. with curved surfaces on its side which faces the valve element 10 and the side which is away from the valve element 10, seen in the direction of the valve axis x.

In the embodiment according to FIG. 8, the resistance element 32d is designed in an essentially disc-like manner as in FIG. 2, but on its outer circumference comprises a collar 34 which is angled away towards the valve element 10. The collar 34 forms an angled wall which in contrast to the collar 33 according to FIGS. 1 and 17 does not extend parallel to the valve axis x but at an angle to this, so that the collar 34 has a conical shape. In the embodiment according to FIG. 9, the resistance element 32e has a freeform with corrugated surfaces. The force engagement via the fluid flow can be adapted by way of the different surface designs of the resistance element 32 to 32e, so that as a whole a desired equilibrium of the forces which act upon the valve element 10 can be realised, in order to stabilise the opening procedure of the valve element 10.

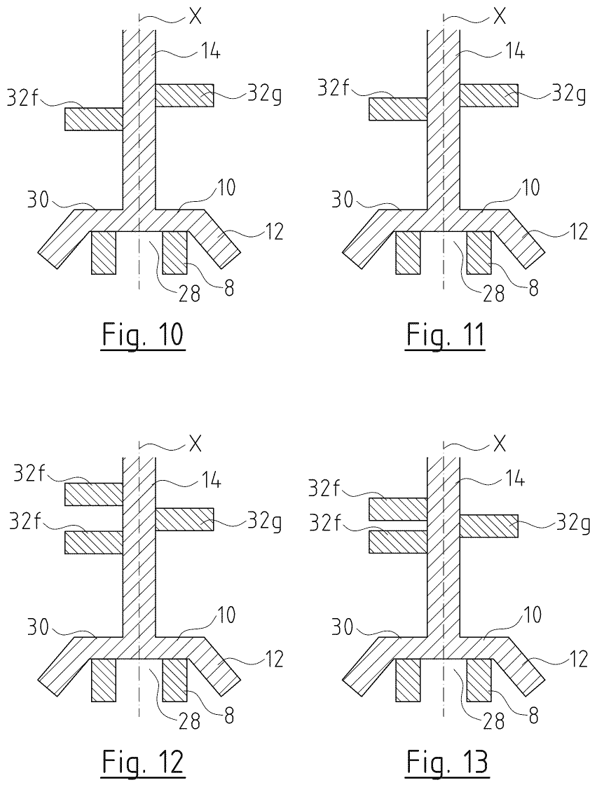

In the previously described embodiment examples, the resistance elements 32 are designed in an essentially symmetrical manner with respect to the valve axis x. However, it is to be understood that an asymmetrical design is also possible, as is described hereinafter by way of FIG. 10 to 16. In the embodiment example according to FIG. 10, resistance elements 32f and 32g are provided and these do not extend annularly around the whole circumference of the valve axis x, but in contrast are each arranged at only one side of the valve axis x, i.e. in a limited circumferential region, and are designed for example in a semicircular manner. The resistance element 32f and the resistance element 32g are herein offset to one another in the direction of the valve axis x. This offset is designed somewhat smaller in FIG. 11. In the embodiment examples according to FIGS. 12 and 13, two resistance elements 32f which are each distanced to one another are provided on one side of the valve axis x, whereas only one resistance element 32g is provided at the diametrically opposite side or the opposite circumferential region. In the embodiment example according to FIG. 12, the resistance elements 32f are distanced further to one another in the axial direction x than in the embodiment example according to FIG. 13.

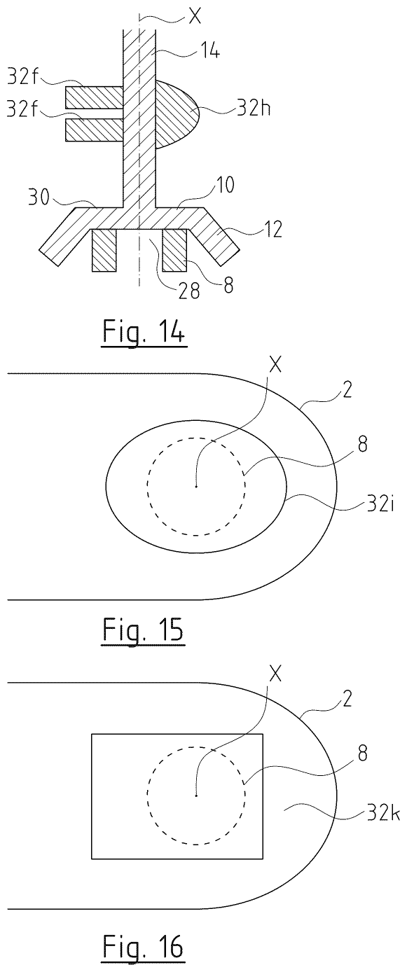

The embodiment example according to FIG. 14 is designed in a similar manner to the embodiment according to FIG. 13. It is merely the resistance element 32g which is replaced by a resistance element 32h with a bulging shape and a greater axial length in the direction of the valve axis x. The FIGS. 15 and 16 each in a schematic plan view show further asymmetrical designs of resistance elements 32e and 32k. In the embodiment according to FIG. 15, the resistance element 32e has an elliptical shape but is arranged essentially centred to the valve axis x. The resistance element 32k according to FIG. 16 has a rectangular shape and is arranged laterally offset to the valve axis x, i.e. asymmetrically.

All the asymmetrical arrangements of the resistance elements 32f to 32k according to FIGS. 10 and 16 permit e.g. an improved adaptation to the valve housing 2 and to the flow path which is defined by this and which is directed towards the outlet connection stub 6. Inasmuch as this is concerned, the flow does not run parallel to the valve axis x but in a lateral direction towards the outlet connection stub 6 at the outlet side of the valve element 10. Despite this, a uniform force action in the direction of the valve axis x can be realised via the resistance elements 32 due to the asymmetrical arrangement of the resistance elements 32.

It is to be understood that all the embodiments of resistance elements 32 to 32k as have been described above could also be realised in further modifications and in particular also combinations, depending on the demands in flow technology and the occurring pressures.

While specific embodiments of the invention have been shown and described in detail to illustrate the application of the principles of the invention, it will be understood that the invention may be embodied otherwise without departing from such principles.

### LIST OF REFERENCE NUMERALS

2 valve housing
4 pressure connection stub
6 discharge connection stub
8 valve seat
10 valve element
12 collar
14 stem
16 guide plate
18 contact disc
20 contact disc
22 threaded sleeve
24 spring housing
26 compression spring
28 pressure side
30 outlet side
32 (32, 32a-32k) resistance elements
33,34 angled wall, collar
X valve axis

1. An overpressure safety valve, configured to open on exceeding a pressure maximal value, the overpressure safety valve comprising:
a valve element which is movable along a valve axis, with a pressure side; and an outlet side which is away from the pressure side in the direction of the valve axis; and
at least one resistance element wherein the valve element at the outlet side is connected to the at least one resistance element which is distanced to the valve element and which is situated in a flow path at the exit side of the valve element.

2. An overpressure safety valve according to claim 1, wherein the at least one resistance element is configured in disc-like manner.

3. An overpressure safety valve according to claim 1, wherein the at least one resistance element comprises at least one angled surface.

4. An overpressure safety valve according to claim 1, wherein the at least one resistance element comprises an angled-away wall on at least one surface.

5. An overpressure safety valve according to claim 1, wherein a free space is formed in the circumferential region of the valve element.

6. An overpressure safety valve according to claim 1, wherein the valve element is configured as a valve disc which with the pressure side can come into sealing bearing contact on a valve seat.

7. An overpressure safety valve according to claim 1, wherein the valve element is configured in a pot-like manner with an annular wall which surrounds a valve seat or with a collar which surrounds the valve seat.

8. An overpressure safety valve according to claim 1, wherein the valve element is spring-biased and is forced into a position bearing on a valve seat by way of the spring biasing.

9. An overpressure safety valve according to claim 1, wherein the valve element at the outlet side comprises a stem which extends in the direction of the valve axis and which carries the at least one resistance element.

10. An overpressure safety valve according to claim 1, wherein the at least one resistance element comprises at least one surface which extends obliquely to the valve axis.

11. An overpressure safety valve according to claim 1, wherein the at least one resistance element comprises at least one curved surface.

12. An overpressure safety valve according to claim 1, wherein the at least one resistance element tapers outwards in a direction radial to the valve axis.

13. An overpressure safety valve according to claim 1, wherein the at least one resistance element is configured symmetrically to the valve axis.

14. An overpressure safety valve according to claim 1, wherein the at least one resistance element is configured asymmetrically to the valve axis.

15. An overpressure safety valve according to claim 1, further comprising at least another resistance element wherein several resistance elements are arranged successively and distanced to one another in the direction of the valve axis in at least one circumferential region with respect to the valve axis.

16. An overpressure safety valve according to claim 1, further comprising a cylinder wall, which is arranged at the outlet side of the valve element at a distance to the valve seat such that at least on opening the valve a resistance element enters into a space which is surrounded by the cylinder wall.

17. An overpressure safety valve according to claim 3, wherein the at least one angled surface extends transversely and normally to the valve axis.

18. An overpressure safety valve according to claim 4, wherein the angled-away wall faces the valve element, on an outer circumference.

19. An overpressure safety valve according to claim 5, wherein the free space is formed in a circumferential region of the at least one resistance element.

20. An overpressure safety valve according to claim 1,wherein the at least one resistance element is configured asymmetrically to the valve axis and projects further in a radial direction with respect to the valve axis in a first circumferential region than in a second circumferential region.
